(19) United States
(12) Patent Application Publication
(10) Pub. No.: US 2011/0100981 A1
(43) Pub. Date: May 5, 2011

(54) DEMAGNETIZATION SYSTEM AND METHOD

(75) Inventor: Tee Yen Lim, Pahang (MY)

(73) Assignee: SHAWCOR LTD., Toronto, ON (CA)

(21) Appl. No.: 12/935,015

(22) PCT Filed: Mar. 28, 2008
(86) PCT No.: PCT/SG08/00096

§ 371 Date: Jan. 11, 2011

(51) Int. Cl. H05B 6/10; H01F 13/00

(52) U.S. Cl. 219/635; 361/267

(57) ABSTRACT

There is disclosed a method and system for demagnetizing an object. The method includes the step of applying a substantially uniform electromagnetic field to a magnetized object under condition to substantially demagnetize said object.

### TECHNICAL FIELD

The present invention generally relates to a method for demagnetizing an object such as a pipe. The present invention also relates to a system for performing the same.

### BACKGROUND

Residual magnetism may be induced in conductive materials such as metal objects during its fabrication or manipulation where induction heating or electricity is applied. Residual magnetism is a major cause of concern for the pipe manufacturing and fabrication industries in which the fabrication of pipes occurs on an industrial scale. For example during the process of coating pipes, metal pipes are usually pre-heated using induction coils. This results in the induction of residual magnetism within the pipes. One major drawback associated with residual magnetism within the pipes is the problem of arc blowing during welding.

Arc blowing is the phenomenon that occurs in direct current (DC) welding when the interaction between the magnetic field present in the pipes and welding arc results in the arc being deflected sideways. This may lead to the introduction of defects in the weld, which in turn compromises the mechanical properties of the weld. Moreover, production efficiency is significantly reduced, as a large amount of time and resources must be employed to rectify the problems associated with defective welding. Hence, to reduce the occurrence of residual magnetism, demagnetization of objects such as pipes prior to welding is required.

In one known method for demagnetizing system, objects are demagnetized using an open magnet circuit with a coil, in which the object is passed through the coil emitting a constant alternating current. The magnet core is applied onto the object and the alternating current is switched on. Thereupon the magnet core is slowly pulled away from the object by hand. With this, the frequency of the supply voltage of the coil is moved slowly up to the resonance frequency of the associated oscillation circuit, whereupon the voltage is reduced and thus the amplitude of the alternating field acting on the parts to be demagnetized is reduced. A disadvantage of this method is that the demagnetization procedure is greatly influenced by surrounding conditions and may not be precisely reproduced. Hence, the demagnetization may be incomplete. Another disadvantage of this method lies in the fact that a lot of time is required for the approach to the resonance frequency. The time required is so large that an efficient demagnetization of objects is not possible with a single pass-through method.

In another known method, the object to be magnetized is moved through a coil to which pulses of current are applied to produce magnetic field pulses of alternating polarity and of substantially constant durations and magnitudes with constant repetition rates. Besides also having a variety of parameters to manipulate, another drawback related to this method is that a complex control system may be required to control, synchronize and vary the pulse frequency, alternating polarity and repetition rate.

Moreover, most of the known methods and systems for demagnetization are limited for use in isolated objects and are not suitable for demagnetizing objects in an in-line production process, such as line-pipes. The objects have to be manually removed from the process line and demagnetized in a separate step, which can be onerous and can increase the likelihood of the object being damaged due to the excessive amount of handling required. It has also been shown that several of the known demagnetizing methods do not yield consistent results. Moreover, known methods are particularly limited to the treatment of the ends of the pipes which does not necessarily solve the problem of residual magnetism completely.

There is a need to provide a method and system for demagnetizing an object, such as a pipe, which overcomes, or at least ameliorates, one or more of the disadvantages described above.

### SUMMARY OF INVENTION

According to a first aspect, there is provided a demagnetization method comprising the step of applying a substantially uniform electromagnetic field to a magnetized object under conditions to substantially demagnetize said object. Advantageously, the object may be an elongate object such as a pipe.

In one embodiment, the applying step comprises applying the electromagnetic field at an opposite polarity to said magnetized object. In another embodiment, the magnitude of the electromagnetic field of opposite polarity is of substantially the same magnitude as the degree of magnetization as said magnetized object. Advantageously, the electromagnetic field produced by the coil is able to oppose and negate the magnetic field of the magnetized object

More advantageously, the object to which the substantially uniform electromagnetic field has been applied does not have substantial residual magnetism.

In one embodiment the demagnetization method comprising the step of passing said object between a pair of coils capable of generating said substantially uniform electromagnetic field therebetween. Advantageously, the substantially uniform electromagnetic field is capable of negating the magnetic field present in the object.

In another embodiment the coil pair are arranged in a Helmholtz configuration. Advantageously, this results in the production of a substantially uniform field between the coils.

According to a second aspect, there is provided a pipe production process comprising the step of applying a substantially uniform electromagnetic field to a magnetized pipe under conditions to substantially demagnetize said pipe.

In one embodiment, said applying step is undertaken on a production line of said pipe. Advantageously, this eliminates the need for the additional step of removing the pipe from the production line for demagnetization. This reduces wastage of manpower and time, which in turn improves production efficiency. More advantageously, as there is no need for excessive handling of the pipe, the likelihood of damaging the pipe is significantly reduced.

According to a third aspect, there is provided a demagnetization system comprising means for applying a substantially uniform electromagnetic field to a magnetized object. Advantageously, the means for applying a substantially uniform electromagnetic field comprises a coil pair which is easy to manipulate and commercially available.

In one embodiment, the demagnetization system further comprises a means for moving said object relative to said coil pair. Advantageously, this enables the magnetized object to pass through the substantially uniform electromagnetic field generated by the coil pair.

In one embodiment, the demagnetization system further comprises a measuring means for measuring the level of magnetization in said object. Advantageously, the measurement of the magnetic field strength by the measuring means enables the operator to determine the magnitude and polarity of the current that is required to be supplied to the coil pair so that the object is effectively demagnetized.

In another embodiment, the demagnetization system further comprising a control means for controlling the amplitude and direction of the current supplied to said coil pair. Advantageously the control means is able to receive feedback from the measuring means. More advantageously, the control means enables the entire demagnetizing process to be automated, which increases the efficiency of the whole process. This is a particular advantage wherein the demagnetization system and method are incorporated in an in-line production process, such as a coating process of a pipe in which the pipe has been subjected to induction heating and thereby magnetized.

According to a third aspect, there is provided a system for manufacturing a pipe incorporating the demagnetization system as defined above.

### DEFINITIONS

The following words and terms used herein shall have the meaning indicated:

The terms “degaussing”, “demagnetizing” and grammatical variations thereof, are used interchangeably herein and broadly refer to the substantial removal of magnetic fields associated with an object.

Unless specified otherwise, the terms “comprising” and “comprise”, and grammatical variants thereof, are intended to represent “open” or “inclusive” language such that they include recited elements but also permit inclusion of additional, unrecited elements.

The word “substantially” does not exclude “completely” e.g. an object which is “substantially demagnetized” may be completely demagnetized. Where necessary, the word “substantially” may be omitted from the definition of the invention.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

### DETAILED DISCLOSURE OF EMBODIMENTS

Exemplary, non-limiting embodiments of a demagnetization method, pipe production process and a demagnetization system will now be disclosed. The method comprising the step of applying a substantially uniform electromagnetic field to a magnetized object under conditions to substantially demagnetize said object.

In one embodiment, before the step of passing, said object is subjected to a heating step which causes said object to be magnetized. The heating step may be induction heating.

In one embodiment, the step of applying is carried out when said object is still on the production line of said object. The step of applying may be carried out at the start of the production line, at the end of the production line, in between the start and finish of the production line or all of the aforementioned. In another embodiment, the step of applying is carried out anywhere in the production line.

In one embodiment, the demagnetization method comprises the step of passing said object between a pair of coils capable of generating said substantially uniform electromagnetic field therebetween. The passing step may comprise passing said object through said pair of coils. More than one pair of coils may be used.

In one embodiment, the step of passing is carried out by means for moving. The means for moving may move the object relative to the coils, or the coils relative to the object, or both. The means for moving may be a conveyor such as an endo-conveyor, or a roller capable of moving the object relative to the coils. The means for moving may be electrically powered by an external power source.

The object that may be demagnetized by the disclosed method may be a substantially elongate object that may be substantially tubular. The elongate object may be substantially symmetrical. In one embodiment, the tubular elongate object is generally rectangular in cross-section at a normal angle relative to the longitudinal axis of said object. In another embodiment, the tubular elongate object is generally circular or oval-shaped in cross-section at a normal angle relative to the longitudinal axis of said object.

In one embodiment, the object that may be demagnetized is selected from the group consisting of rods, pipes, tubes and bars. The object may be coated with another material or uncoated. The object may be coated with another material before, during or after the passing step. In one embodiment, the object to be demagnetized is a pipe, such as a line-pipe, typically used in the petroleum and marine industries. In one embodiment, the object after undergoing the disclosed demagnetizing process has substantially no residual magnetism or a magnetic field strength of at less than 15×10⁻⁴ Tesla.

In one embodiment, the coil pair is made of conductive materials such as metals and alloys thereof. Exemplary metal and metal alloys include steel, stainless steel, iron, zinc, silver, nickel, titanium, indium, molybdenum, cobalt, aluminum, copper, tungsten, titanium, ti-tungsten and alloys thereof.

The coil pair may also be substantially symmetrical in shape. The shape of the coils may be selected from the group consisting of circles, rectangles, squares, rhombuses, ovals, hexagons and octagons.

In one embodiment, the coil pair is substantially circular. In another embodiment, each of the coils in the coil pair is of substantially the same radius, “R”. The coil pair may have a diameter that is larger than the longest straight-line distance between any two points on the object, such that the object is able to pass through the area enclosed within each of the coil pair without obstruction.

The coil pair may be arranged in a configuration that allows a substantially uniform magnetic field to be produced in the volume space that runs throughout the transverse length between the coil pair. In one embodiment, the coils in the coil pair are coaxial. In another embodiment, each of the coils is a solenoid and is optionally further made up of a plurality of turns of primary coils. The turns of primary coils may be from about 2 turns to about 10 turns. In one embodiment, the coil pair are arranged in a substantially Helmholtz configuration.

The substantially uniform magnetic field strength created by the coil pair may be from about 1×10⁻⁴ Tesla to about 80×10⁻⁴ Tesla. The electromagnetic field strength that can be applied to the object can be calculated from the following equation:

$$B = {\vert \frac{4}{5} \vert}^{3 / 2} \frac{{μ}_{0} nI}{R}$$

where B is the magnetic flux density,

μₒ=4π×10⁻⁷ TmA⁻¹≈12.5664×10⁻⁷ TmA⁻¹, [permeability of free space]

I is the current in Amperes,

R is the coil radius in Meters,

n is the turn number in a coil.

The transverse separation distance between the pair of coils may be between the length of R and 2R, wherein “R” is the radius of the coils in meters. In another embodiment, the transverse separation distance between the pair of coils may be between the length of R and 1.5R or between the length of R and 1.2R. In one embodiment, additional coils can be added such that they may be separated from about R to about 1.2R apart.

In another embodiment said coil pair are coupled to a current source, which is configured, to generate a substantially uniform electromagnetic field between the coil pair. The substantially uniform electromagnetic between the coil pair may be of opposite polarity and substantially the same magnitude as the magnetic field present in the magnetized object. The coils may be independently coupled to a separate power source or may be coupled to the same power source. In one embodiment, the power source is a direct current (DC) power source. In another embodiment, the power source is an alternating current (AC) power source coupled to a rectifier configured to generate a substantially uniform magnetic field between the coil pair.

In one embodiment, the said coil pair is supported by structural supports such as rails, brackets or frames. The structural supports may be non-conductive or insulated. The structural supports may be non-magnetic. The structural supports may also be adjustable to suit the different sizes of the object to be demagnetized

The disclosed demagnetization system may further be comprised of means for measuring the level of magnetism in the object, such as a magnetic field detector selected from the group consisting of a Hall sensor and a gauss meter. The means for measuring the level of magnetism may be used to measure the magnetism level of said object before, after or at any point during the demagnetization process. Trial runs may be conducted to measure the degree of magnetization of the object and appropriate adjustments to change the electromagnetic field produced may be made to nullify the magnetism present in the object, via a feedback loop.

In one embodiment, the system further comprises a control means for controlling the amplitude and direction of the current supplied to the coil pair. The control means may also control the means for moving said object relative to said coils.

The control means may incorporate a processor capable of interrogating a memory having predetermined instructors for moving and operating said moveable means, and also for the supplying desired amount of current to the coils. The control means may be linked to a user interface, such as a keyboard, and a a graphical user interface such as an LCD display for allowing an operator to interact with the control means.

In one embodiment, the control means comprises a memory having a computer algorithm thereon for storing said predetermined instructions. Advantageously, the LCD display linked to the control means is touch sensitive and is capable of relaying user's instructions to the other components of the control unit.

The control means may receive feedback from the detector that senses the polarity and strength of the residual magnetic field in the object.

The control means may be able to store and process the current supply parameters (i.e amplitude and polarity) input by a user.

Various algorithms can be used in order to control the current output to the coil pair. The system may use a predetermined program setting values as a starting point and over time these settings can be customized according to the user's requirements.

The demagnetizing system itself may be monitored remotely by a hard wired communication link to the control means, or by radio communications or by means of a portable data log off.

### BRIEF DESCRIPTION OF DRAWINGS

The accompanying drawings illustrate a disclosed embodiment and serve to explain the principles of the disclosed embodiment. It is to be understood, however, that the drawings are designed for purposes of illustration only, and not as a definition of the limits of the invention.

FIG. 1 is a process flow diagram showing the demagnetization system utilizing the method disclosed herein.

FIG. 2 is a schematic diagram of an orthogonal view of a Helmholtz coil configuration.

FIG. 3 is a schematic diagram of a top view of the Helmholtz coil configuration of FIG. 2.

FIG. 4a and FIG. 4b are pictures of the demagnetization system disclosed herein in a demagnetization process of a pipe.

### DETAIL DESCRIPTION OF DRAWINGS

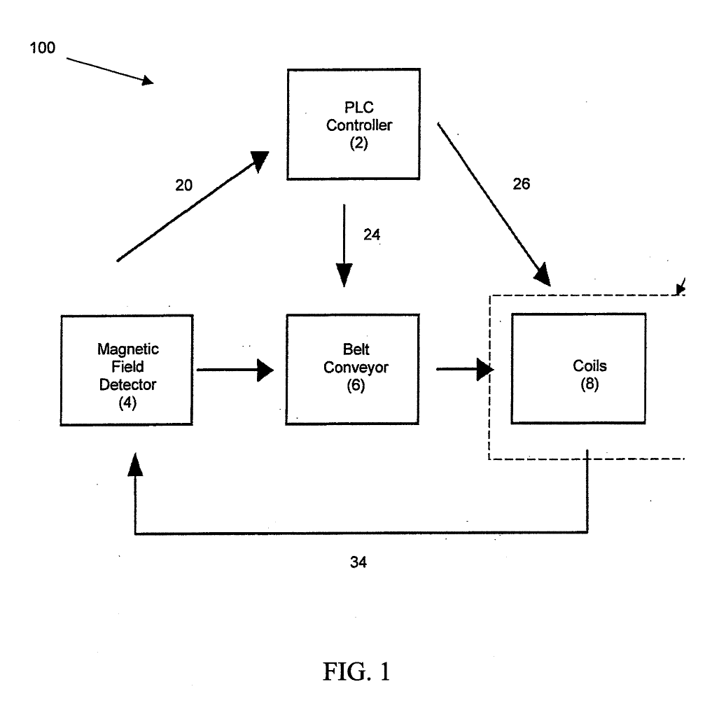

Referring to FIG. 1 there is provided a process flow diagram 100 of a demagnetization method disclosed herein for demagnetizing an object in the form of a line-pipe (not shown). The line-pipe has some residual magnetism due to induction heating that has been performed on the line-pipe as part of the coating processes during production of the pipe. A magnetic field detector 4 in the form of a hand held Gauss meter, is used to determine the degree of magnetization on the line pipe directly after a coating has been applied thereon. The line-pipe travels along a movement means in the form of belt conveyor 6 from the point where the coating has been applied directly to where a demagnetization system 9 is located in the pipe production facility.

The magnetic field detector 4 detects the polarity and magnitude of the residual magnetism of the line-pipe. A first signal 20, is relayed from the detector 4 to a control means in the form of programmable logic controller (PLC) 2. The PLC 2 receives, assesses and stores the data associated with the signal 20, which contains the information on the polarity and magnitude of the residual magnetism in the line-pipe.

The demagnetization system 9 includes a pair of coils 8, which are arranged in a Helmholtz configuration and are held by supporting structures (not shown).

The PLC 2 then sends a second signal 24 to the belt conveyor 6 which transports the line-pipe through the pair of coils 8 of the degaussing system 9. At the same time, the PLC 2, based on a pre-programmed algorithm, determines the magnitude and polarity of the current 26 to be supplied to the coil pairs 8, such that a substantially uniform electromagnetic field of substantially the same magnitude but of opposite polarity as the residual magnetism present in the line pipe, is produced in the volume space between the two coils 8 to negate the residual magnetism that exist within the line-pipe.

Throughout the degaussing process, the belt conveyor 6 continuously transports the line-pipe through the two coils. When the line pipe exits from the volume space enclosed between the two coils, another magnetic field detector (not shown) may be employed 34 to detect if any substantial amount of magnetic field is left in the line-pipe. If there is a need to further demagnetize the line-pipe, the whole demagnetization process may be repeated by activating the belt conveyor 6 to move in the reverse direction to send the line-pipe through the coils 8 in the reverse direction. If the belt conveyor 6 forms an enclosed circuit, the line-pipe may be transported back to its starting point instead and the whole demagnetization process being repeated again.

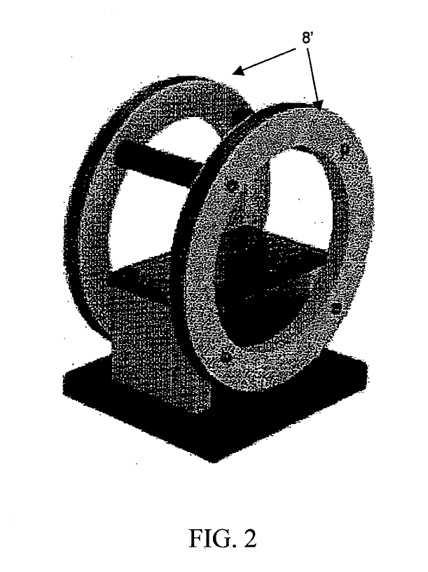

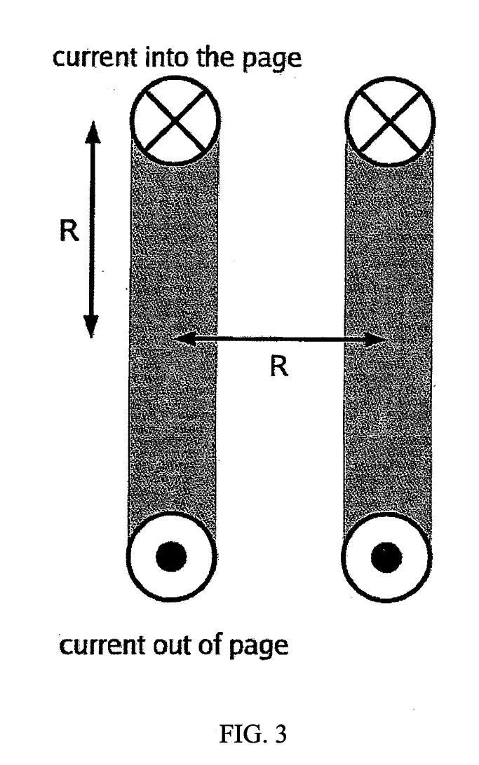

Referring to FIG. 2 and FIG. 3, there is shown a Helmholtz coil configuration. The coils 8′ are separated by a distance R, which is the length of the radius of the coil.

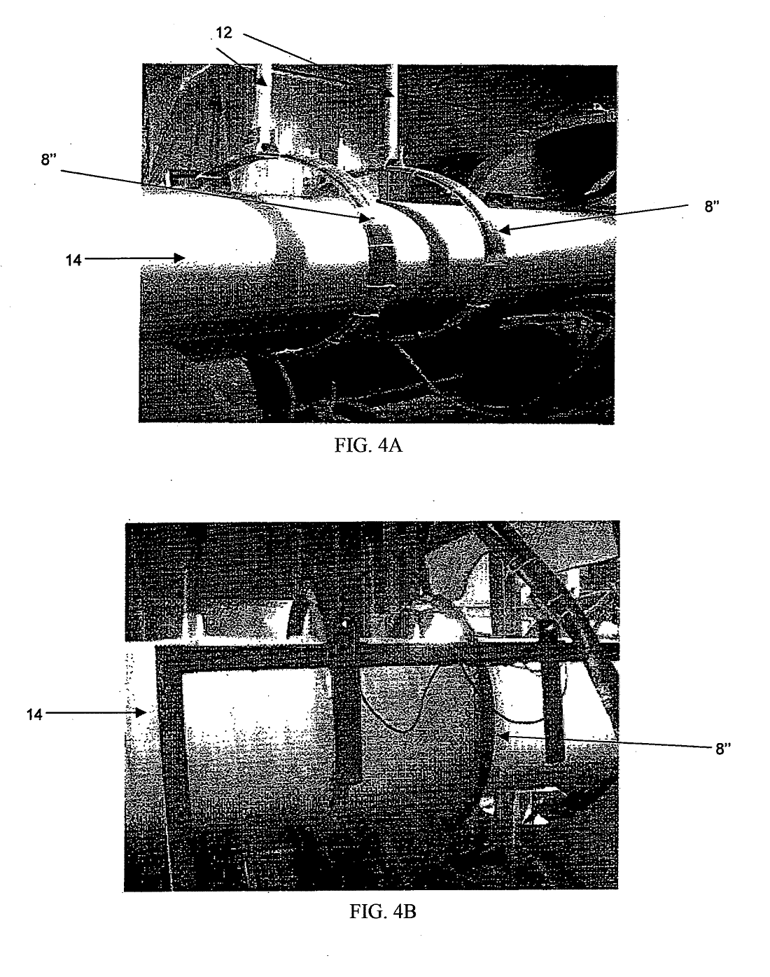

FIG. 4a and FIG. 4b show the demagnetization system disclosed herein in a demagnetization process. The coils 8″ are supported by supports 12, which are overhanging from the ceilings or a sturdy elevated structure. The line-pipe 14 is passed through the volume space between the two coils 8″. The line-pipe 14 exiting from the volume space between the two coils is substantially free from magnetism.

### APPLICATIONS

The disclosed demagnetization method, system and pipe production process may be used for a variety of applications in industries dealing with large-scale manipulation (such as pipe coating) and production of pipes. Advantageously, the disclosed demagnetizing method and system can be employed in a production line without the need to remove the object from the production line. This reduces the amount of time and additional process steps that are normally required in conventional demagnetization processes. More advantageously, as there is minimized handling of the object (as removal from the production line is not required), the risks of damages associated with excessive handling is significantly lowered.

As the disclosed demagnetization method and system are able to demagnetize objects such that almost no residual magnetization is present within the pipe, the costs normally associated with conventional demagnetizing methods is reduced because there is no need for repeated demagnetization.

Advantageously, the objects that have been demagnetized using the disclosed method and system are substantially free of residual magnetism. As a result, the likelihood of arc blowing during welding is mitigated.

Advantageously, the disclosed method and system for demagnetizing objects is simple and easy to use as the only two parameters, which is the magnitude and direction of current through the coils, have to be adjusted for a complete demagnetization of the object. More advantageously, due to the small amount of parameters that have to be adjusted, a complex control system which may be expensive, is not required.

As a direct current may be used in the disclosed method and system, a commercially obtainable and economically priced direct current power supply can be used.

Advantageously, the disclosed method of demagnetization is not limited to the treatment of the ends of the pipes and is effective in solving the problem of residual magnetism completely.

While reasonable efforts have been employed to describe equivalent embodiments of the present invention, it will be apparent to the person skilled in the art after reading the foregoing disclosure, that various other modifications and adaptations of the invention may be made therein without departing from the spirit and scope of the invention and it is intended that all such modifications and adaptations come within the scope of the appended claims.

1. A demagnetization method comprising the step of applying a substantially uniform electromagnetic field to a magnetized object under conditions to substantially demagnetize said object.

2. A demagnetization method as claimed in claim 1, wherein the applying step comprises applying the electromagnetic field at an opposite polarity to said magnetized object.

3. A demagnetization method as claimed in claim 2, wherein the magnitude of the electromagnetic field of opposite polarity is of substantially the same magnitude as the degree of magnetization as said magnetized object.

4. A demagnetization method as claimed in any one of the preceding claims, wherein said object is substantially elongate in shape.

5. A demagnetization method as claimed in claim 4, wherein said elongate object is substantially tubular.

6. A demagnetization method as claimed in claim 5, wherein said tubular object is a pipe.

7. A demagnetization method as claimed in any one of the preceding claims, wherein before said applying step, said object is subjected to a heating step which causes said object to become magnetized.

8. A demagnetization method as claimed in claim 7, wherein said heating step comprises induction heating.

9. A demagnetization method as claimed in any one of the preceding claims comprising the step of passing said object between a pair of coils capable of generating said substantially uniform electromagnetic field therebetween.

10. A demagnetization method as claimed in claim 9, wherein said passing step comprises passing said object through said pair of coils.

11. A demagnetization method according to claim 9 or claim 10, wherein said coil pair are of substantially the same radius (R).

12. A demagnetization method according to claim 11, wherein the transverse separation distance between said coil pair is between the length of R and 2R.

13. A demagnetization method according to claim 12, wherein said transverse separation distance is between the length of R and 1.5R.

14. A demagnetization method according to claim 13, wherein said transverse separation distance is between the length of R and 1.2R.

15. A demagnetization method according to any one of claims 9 to 14, wherein said pair of coils is arranged in a Helmholtz configuration.

16. A demagnetization method according to any one of claims 9 to 15, wherein said coil pair is electrically coupled to a source of direct current.

17. A demagnetization method according to any one of the preceding claims comprising the step of measuring the level of said magnetization.

18. A pipe production process comprising the step of applying a substantially uniform electromagnetic field to a magnetized pipe under conditions to substantially demagnetize said pipe.

19. A pipe production process as claimed in claim 18, wherein said applying step is undertaken on a production line of said pipe.

20. A pipe production process as claimed in claim 18 or claim 19, wherein said applying step is undertaken after said pipe has been heated by induction.

21. A pipe production process as claimed in any one of claims 18 to 20, comprising the step of passing said pipe between a pair of coils capable of generating said substantially uniform electromagnetic field therebetween.

22. A pipe production process as claimed in claim 21, wherein said passing step comprises passing said pipe through said pair of coils.

23. A pipe production process as claimed in claim 22, wherein said coil pair is of substantially the same radius (R).

24. A pipe production process as claimed in claim 23, wherein the transverse separation distance between said coil pair is between the length of R and 2R.

25. A pipe production process as claimed in claim 24, wherein said transverse separation distance is between the length of R and 1.5R.

26. A pipe production process as claimed in claim 25, wherein said transverse separation distance is between the length of R and 1.2R.

27. A pipe production process as claimed in any one of claims 21 to 26, wherein said pair of coils is arranged in a Helmholtz configuration.

28. A pipe production process as claimed in claim any one of claims 21 to 27, wherein said coil pair is electrically coupled to a direct current source.

29. A demagnetization system comprising means for applying a substantially uniform electromagnetic field to a magnetized object.

30. A demagnetization system according to claim 29 wherein said means for applying comprises a pair of coils.

31. A demagnetization system according to claim 30, wherein each of said coil pair are both of substantially the same radius (R).

32. A demagnetization system according to claim 31, wherein the transverse separation distance between said coil pair is between the length of R and 2R.

33. A demagnetization system according to claim 32, wherein said transverse separation distance is between the length of R and 1.5R.

34. A demagnetization system according to claim 33, wherein said transverse separation distance is between the length of R and 1.2R.

35. A demagnetization system as claimed in any one of claims 30 to 34, wherein said pair of coils is arranged in a Helmholtz configuration.

36. A demagnetization system as claimed in any one of claims 30 to 35, wherein said coil pair is electrically coupled to a direct current source.

37. A demagnetization system as claimed in any one of claims 30 to 36, wherein the substantially uniform electromagnetic field is generated between said coil pair.

38. A demagnetization system as claimed in any one of claims 30 to 37, further comprising means for moving said object relative to said coil pair.

39. A demagnetization system as claimed in claim 38, wherein said means for moving comprises a conveyor.

40. A demagnetization system as claimed in any one of claims 29 to 37, further comprising measuring means for measuring the level of magnetization of said object.

41. A demagnetization system as claimed in claim 40, wherein said measuring means comprises a gauss meter.

42. A demagnetization system as claimed in any one of claims 29 to 41, wherein said object is a pipe.

43. A system for manufacturing a pipe incorporating the demagnetization system of claim 42.
